(19) United States
(12) Patent Application Publication
(10) Pub. No.: US 2022/0286903 A1
(43) Pub. Date: Sep. 8, 2022

(54) IN-VEHICLE COMMUNICATION DEVICE

(71) Applicant: Mitsubishi Electric Corporation, Tokyo (JP)

(72) Inventor: Takashi MAEDA, Tokyo (JP)

(73) Assignee: Mitsubishi Electric Corporation, Tokyo (JP)

(21) Appl. No.: 17/358,253

(22) Filed: Jun. 25, 2021

(30) Foreign Application Priority Data
Mar. 5, 2021 (JP) 2021-035034

(51) Int. Cl. H04W 28/02; H04W 4/44; H04W 4/46

(52) U.S. Cl. CPC H04W 28/0289; H04W 28/0284; H04W 4/44; H04W 4/46; G08G 1/161

(57) ABSTRACT

To obtain an in-vehicle communication device which can avoid tightness or congestion of communication in the environment in which there coexist vehicle-to-vehicle and road-to-vehicle communication. Information of an own vehicle is periodically wirelessly transmitted by a wireless transmission section, and also, information wirelessly transmitted from a roadside device is received by a wireless reception section, via the road-to-vehicle and vehicle-to-vehicle communication, wherein a configuration is such that when the information transmitted from the roadside device is received by the wireless reception section, information on an own vehicle is extracted from the received information by an own vehicle information extraction section, and that when the information on the own vehicle is extracted by the own vehicle information extraction section, the periodical transmission of the information on the own vehicle from the wireless transmission section is stopped.

### BACKGROUND OF THE INVENTION

### Field of the Invention

The present application relates to the field of an in-vehicle communication device which carries out road-to-vehicle and vehicle-to-vehicle communication.

### Description of the Related Art

A V2X (Vehicle to X) communication technology which carries out wireless communication between a vehicle and a vehicle and between a road and a vehicle is known. In a system using the vehicle-to-vehicle communication, each of vehicles periodically broadcast transmits its own information, such as its position, speed, and orientation, to its surrounding vehicles or the like. The transmitted information is utilized for anticollision purposes or the like by the reception side vehicles.

In the system using the vehicle-to-vehicle communication, when the number of vehicles increases, the volume of communication increases in proportion thereto, leading to the possibility of tightness or congestion of communication.

Non-patent Literature 1 provides a method of controlling congestion with vehicle-to-vehicle communication.

[Non-patent Literature 1] SAE J2945/1 On-Board System Requirements for V2V Safety Communications

In Non-patent Literature 1, however, road-to-vehicle communication is not taken into consideration.

As an example of a system using road-to-vehicle communication, there is a system in which an on-road vehicle and its surrounding vehicles or the like are detected using a sensor installed on the roadside at an intersection or the like, and a detection result of the sensor is periodically broadcast transmitted to the surrounding vehicles or the like via road-to-vehicle communication and utilized for anticollision purposes or the like.

This system has a problem in that as the number of vehicles increases, the volume of road-to-vehicle communication, as well as the volume of vehicle-to-vehicle communication, also increases, so that there is the possibility of tightness or congestion of communication.

### SUMMARY OF THE INVENTION

The present application has been made to solve the above problem, and an object of the present application is to provide an in-vehicle communication device which can avoid tightness or congestion of communication in the environment in which there coexist vehicle-to-vehicle and road-to-vehicle communication.

The in-vehicle communication device disclosed in the present application carries out road-to-vehicle and vehicle-to-vehicle communication. The device includes a transmission circuitry which transmits information of an own vehicle; a reception circuitry which receives the transmitted information; and an own vehicle information extraction circuitry which, when the information is received by the reception circuitry, extracts information on the own vehicle from the information. The device is configured so that the transmission circuitry stops the information transmission when the information on the own vehicle is extracted by the own vehicle information extraction circuitry.

According to the in-vehicle communication device disclosed in the present application, it is possible to avoid tightness or congestion of communication in the environment in which there coexist vehicle-to-vehicle and road-to-vehicle communication.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic view showing a communication system in which is used an in-vehicle communication device according to the first embodiment.

FIG. 2 is a block diagram showing the outlined configuration of the in-vehicle communication device according to the first embodiment.

FIG. 3 is a flow chart showing the processing of the in-vehicle communication device according to the first embodiment.

FIG. 4 is a schematic view showing a communication system in which is used an in-vehicle communication device according to the second embodiment.

FIG. 5 is a block diagram showing the outlined configuration of the in-vehicle communication device according to the second embodiment.

FIG. 6 is a flow chart showing the processing of the in-vehicle communication. device according to the second embodiment.

FIG. 7 is a block diagram showing the outlined configuration of an in-vehicle communication device according to the third embodiment.

FIG. 8 is a flow chart showing the processing of the in-vehicle communication device according to the third embodiment.

FIG. 9 is a schematic view showing a communication system in which is used an in-vehicle communication device according to the fourth embodiment.

FIG. 10 is a block diagram showing the outlined configuration of the in-vehicle communication device according to the fourth embodiment.

FIG. 11 is a flow chart showing the processing of the in-vehicle communication device according to the fourth embodiment.

FIG. 12 is a diagram showing the hardware configuration of the in-vehicle communication devices according to the first to fourth embodiments.

### DETAILED DESCRIPTION OF THE PREFERRED EMBODIMENTS

### First Embodiment

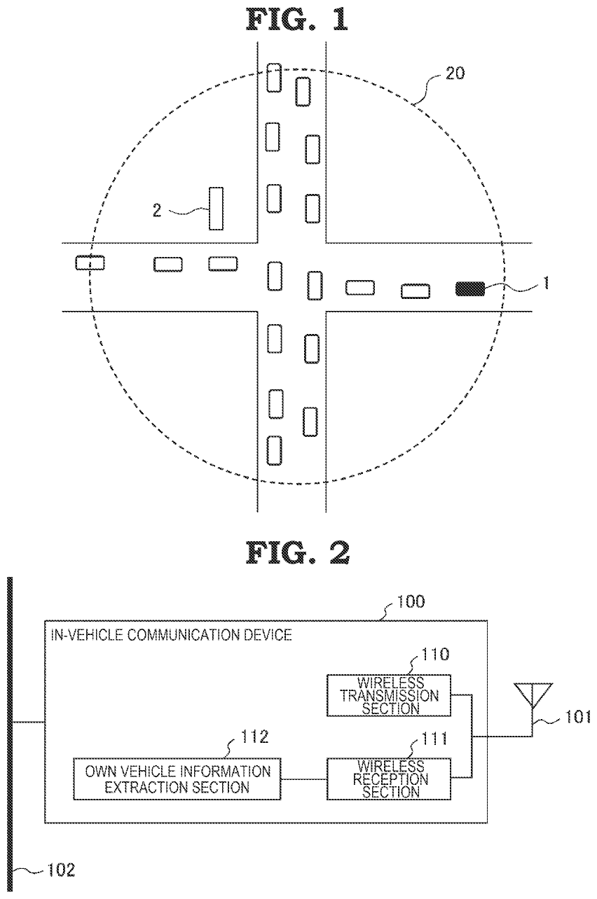

FIG. 1 is a schematic view showing a communication system in which is used an in-vehicle communication device according to the first embodiment.

In FIG. 1, the in-vehicle communication device, being mounted on each of an own vehicle 1 and another vehicle which are running in the intersection, periodically broadcast transmits information of the vehicle, such as its position and speed, to its surroundings via wireless communication. The individual vehicles, not only in the intersection, but always carry out wireless communication while being driven.

A roadside device 2 installed at the intersection of FIG. 1 includes a roadside sensor and periodically broadcast transmits the information (the position, speed, orientation, and the like) of individual vehicles detected in a detection area 20 of the roadside sensor, via wireless communication, to a vehicle or the like existing in the intersection.

FIG. 2 is a block diagram showing the outlined configuration of the in-vehicle communication device according to the first embodiment.

In FIG. 2, an in-vehicle communication device 100 carries out wireless communication, via an antenna 101, with the communication device mounted on another vehicle and with the roadside device 2 installed on the roadside. The in-vehicle communication device 100 is connected to an in-vehicle network 102 and acquires information of the own vehicle, such as its position, speed, and orientation, from the in-vehicle network 102.

The in-vehicle communication device 100 is configured as follows.

A wireless transmission section 110 (the transmission section) periodically transmits the information of the own vehicle acquired from the in-vehicle network 102, through the antenna 101, via. wireless communication. A wireless reception section 111 (the reception section) receives, via the antenna 101, information wirelessly transmitted from another device.

An own vehicle information extraction section extracts information on the own vehicle from the information of a detection result of the roadside sensor which has been transmitted by the roadside device 2 and received by the wireless reception section 111.

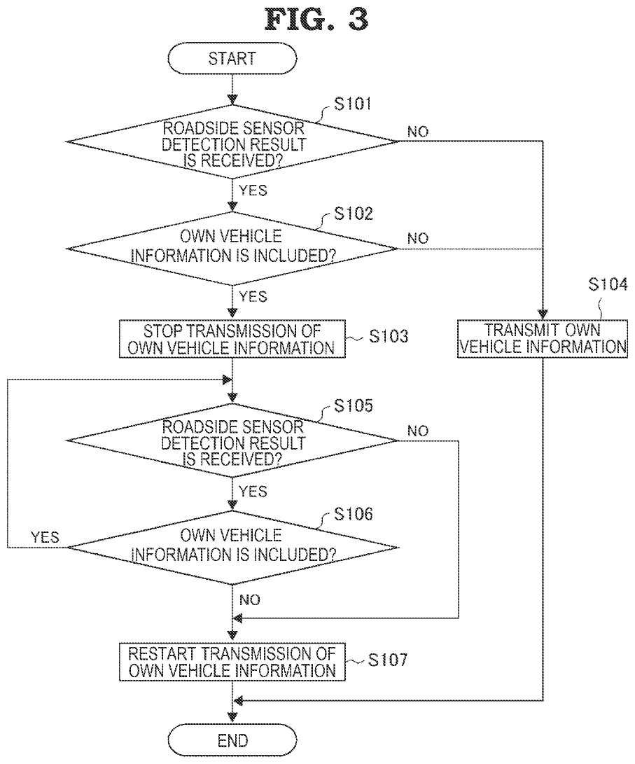

Next, a description will be given of the operation. A description. will be given, using the flow chart of FIG. 3, of the processing of the in-vehicle communication device 100.

Each step of the processing of FIG. 3 is periodically started with a wireless transmission period (of, for example, 100 ms).

In Step S101, the in-vehicle communication device 100 confirms whether or not the wireless reception section 111 has received a detection result of the roadside sensor from the roadside device 2 installed on the roadside.

When the detection result is not received, the operation proceeds to Step S104, and when the detection result is received, the operation proceeds to Step S102.

In Step S102, the in-vehicle communication device 100 is such that the own vehicle information extraction section 112 compares detected information of each vehicle (such as its position, speed, and orientation) with the information of the own vehicle (such as its position, speed, and orientation) acquired from the in-vehicle network 102 and, when there is a detection result, in which a difference therebetween falls within a predetermined range, among the detection results of the roadside sensor received by the wireless reception section 111, extracts it as a detection result corresponding to that of the own vehicle.

When the detection result can be extracted in Step S102, the operation proceeds to Step S103. When the detection result cannot be extracted, the operation proceeds to Step S104.

In Step S103, the in-vehicle communication device 100 stops the transmission of the information of the own vehicle from the wireless transmission section 110. Subsequently, the operation proceeds to Step S105.

In Step S104, the in-vehicle communication device 100 acquires the information of the own vehicle, such as its position, speed, and orientation, from the in-vehicle network 102, and wirelessly broadcast transmits the acquired information of the own vehicle, via the antenna 101, from the wireless transmission section 110, ending the processing.

In Step S105, the in-vehicle communication device 100 confirms whether or not the wireless reception section 111 has newly received a detection result of the roadside sensor from the roadside device 2 installed on the roadside.

When the detection result is not received (for example, when the intersection is passed) in Step S105, the operation proceeds to Step S107. When the detection result is received, the operation proceeds to Step S106.

In Step S106, the in-vehicle communication device 100 carries out the same processing as in Step S102.

When the detection result corresponding to that of the own vehicle can be extracted, the operation returns to Step S105. When the detection result cannot be extracted (for example, when the detection range of the roadside sensor is passed), the operation proceeds to Step S107.

In Step S107, the in-vehicle communication device 100 restarts the transmission of the information of the own vehicle from the wireless transmission section 110, ending the processing.

According to the first embodiment, when it is determined from the information transmitted by the roadside device 2 that the roadside sensor has detected the own vehicle, the in-vehicle communication device 100 stops the processing of periodically wirelessly transmitting the information of the own vehicle.

It is thereby possible, in the environment in which there coexist vehicle-to-vehicle and road-to-vehicle communication, to avoid tightness or congestion of wireless communication even when a large number of vehicles exist in the surroundings.

Even when another vehicle or the like receives the vehicle information transmitted from the own vehicle and utilizes it for anticollision purposes or the like, it is possible to replace it by referring to the information of the own vehicle included in the roadside sensor detection results which can be received from the roadside device 2.

### Second Embodiment

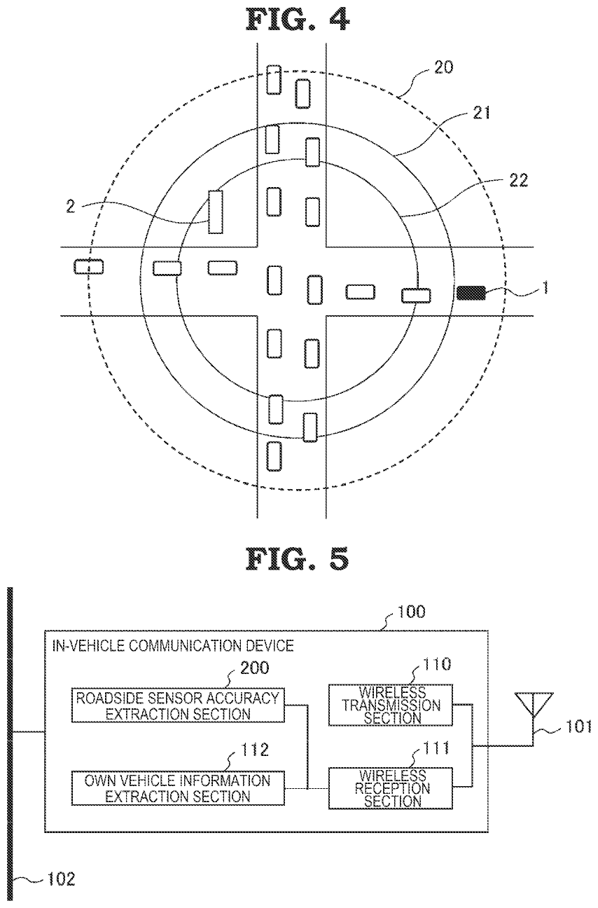

FIG. 4 is a schematic view showing a communication system in which is used an in-vehicle communication device according to the second embodiment.

In FIG. 4, the signs 1 and 2 are identical to those in FIG. 1. FIG. 4 shows the distribution of the detection accuracy of the roadside sensor in the detection area 20. The more inside the detection area 20 as it goes into a detection area 21 of the roadside sensor and further into a detection area 22 of the roadside sensor, the higher the detection accuracy of the roadside sensor.

The roadside device 2 transmits the information on the distribution of the detection accuracy of the roadside sensor, together with the detection results of the roadside sensor, to surrounding vehicles or the like including the own vehicle 1 via wireless communication.

FIG. 5 a block diagram showing the outlined configuration of the in-vehicle communication device according to the second embodiment.

In FIG. 5, the signs 100 to 102 and 110 to 112 are identical to those in FIG. 2. In FIG. 5, a roadside sensor accuracy extraction section 200 is provided in the in-vehicle communication device 100.

The roadside sensor accuracy extraction section 200 extracts the detection accuracy of the roadside sensor in the position of the own vehicle 1 from the information on the distribution of the detection accuracy of the roadside sensor in the detection area 20 which has been transmitted by the roadside device 2 and received by the wireless reception section 111.

Next, a description will be given of the operation.

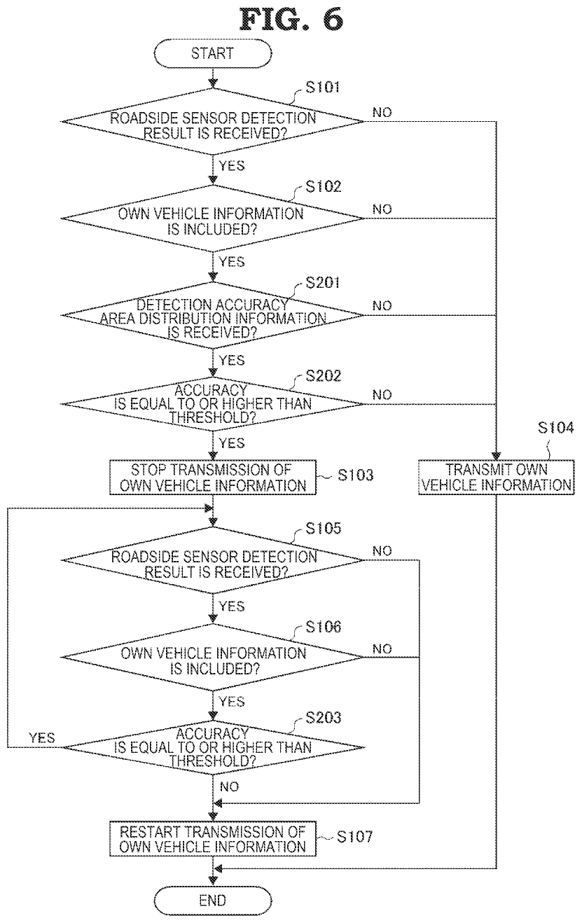

A description will be given, using FIG. 6, of the processing of the in-vehicle communication device 100 according to the second embodiment.

FIG. 6 is such that Steps S201 and S202 are inserted between Steps S102 and S103 of FIG. 3 and that Step S203 is inserted between. Steps S106 and S107. Hereinafter, a description will be given of newly inserted Steps S201 to S203.

In Step S201, the in-vehicle communication device 100 confirms whether or not the wireless reception section 111 has received, from the roadside device 2 installed on the roadside, the information on the distribution of the detection accuracy of the roadside sensor in the detection area 20.

When the information is not received, the operation proceeds to Step S104. When the information is received, the operation proceeds to Step S202.

In Step S202, the in-vehicle communication device 100 is such that the roadside sensor accuracy extraction section 200 extracts the detection accuracy of the roadside sensor in the position of the own vehicle 1 both from the position information of the own vehicle 1 acquired from the in vehicle network 102 and from the information on the distribution of the detection accuracy of the roadside sensor in the detection area 20 which has been received by the wireless reception section 111.

When the extracted accuracy is equal to or higher than a predetermined threshold (a first threshold), the operation proceeds to Step S103. When the extracted accuracy is lower than the threshold, the operation proceeds to Step S104.

In Step S203, the in-vehicle communication device 100 carries out the same processing as in Step S202. When the extracted detection accuracy of the roadside sensor is equal to or higher than the threshold, the operation returns to Step S105. When the extracted accuracy is lower than the threshold, the operation proceeds to Step S107.

According to the second embodiment, the in-vehicle communication device 100 stops the processing of periodically wirelessly transmitting the information of the own vehicle, only when there exists the own vehicle, to a region in which the roadside sensor is detecting vehicles with high accuracy.

It is thereby possible to avoid that another vehicle is in danger of executing processing, such as anticollision, using sensor detection information low in accuracy.

### Third Embodiment

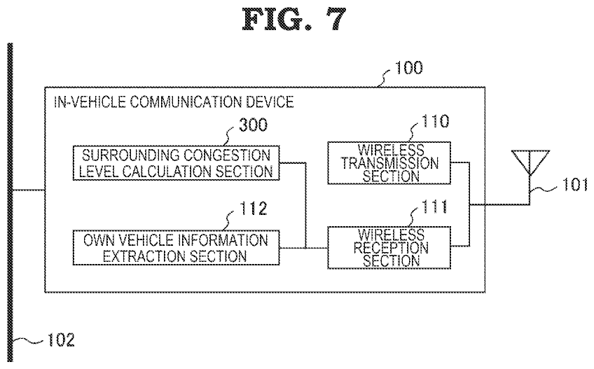

FIG. 7 is a block diagram showing the outlined configuration of an in-vehicle communication device according to the third embodiment.

In FIG. 7, the signs 100 to 102 and 111 to 112 are identical to those in FIG. 2. In FIG. 7, a surrounding congestion level calculation section 300 is provided in the in-vehicle communication device 100. The surrounding congestion level calculation section 300 calculates or estimates the level of congestion around the own vehicle based on the information transmitted from another vehicle and received by the wireless reception section 111.

Next, a description will be given of the operation.

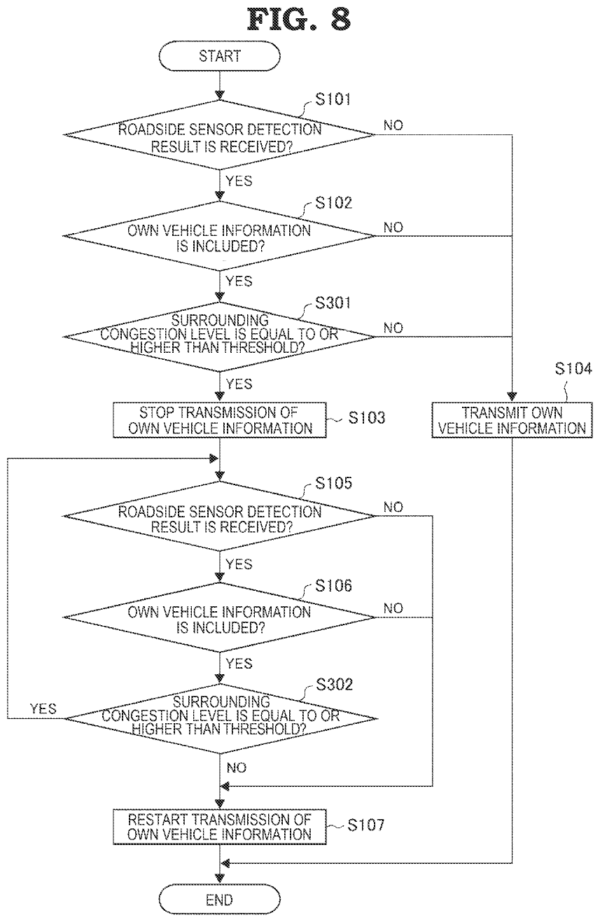

A description will be given, using FIG. 8, of the processing of the in-vehicle communication device 100 according to the third embodiment.

In FIG. 8, the processing of Step S301 is inserted between Steps S102 and S103 of FIG. 3, and the processing of Step S302 inserted between Steps S106 and S107.

Hereinafter, description will be given of the processing details of Steps S301 and S302.

In Step S301, the in-vehicle communication device 100 is such that the surrounding congestion level calculation section 300 calculates or estimates the surrounding congestion level based on the information transmitted from another vehicle and received by the wireless reception section 111. For example, the surrounding congestion level calculation section 300, based on the number of items of information received within a predetermined time, calculates the number of surrounding vehicles and thus calculates the level of congestion.

When the calculated congestion level is equal to or higher than a predetermined threshold (a second threshold), the operation proceeds to Step S103. When the calculated congestion level is lower than the threshold, the operation proceeds to Step S104.

In Step S302, the same processing as Step S301 is carried out.

When the calculated congestion level is equal to or higher than the threshold, the operation returns to Step S105, When the calculated congestion level is lower than the threshold, the operation proceeds to Step S107.

According to the third embodiment, when. it is determined that the roadside device 2 has detected the own vehicle and only when there is a congestion around the own vehicle, the in-vehicle communication device 100 stops the processing of periodically wirelessly transmitting the information of the own vehicle.

For this reason, the processing of the own vehicle does not have to be changed when a large number of vehicles do not exist around the own vehicle and thus the risk of tightness or congestion. of communication is low.

### Fourth Embodiment

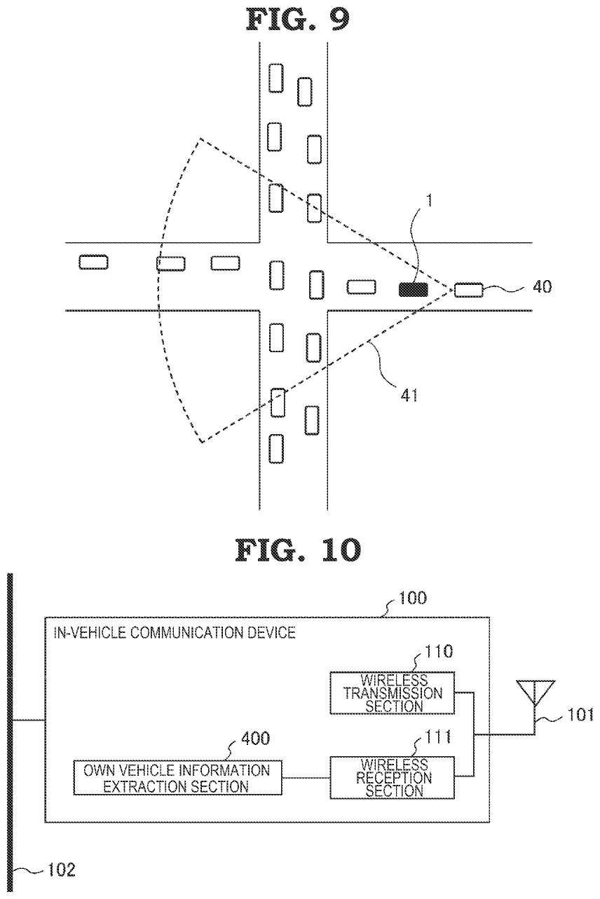

FIG. 9 is a schematic view showing a communication system in which is used an in-vehicle communication device according to the fourth embodiment.

In FIG. 9, another vehicle 40 has an in-vehicle sensor with a detection area 41 ahead thereof and detects a vehicle or the like included in the detection area 41. The other vehicle 40 broadcast transmits a detection result of the in-vehicle sensor including the information of the own vehicle 1, via the communication device and the antenna, to other surrounding devices including the own vehicle 1.

FIG. 10 is a block diagram showing the outlined configuration of the in-vehicle communication device according to the fourth embodiment.

In FIG. 10, the signs 100 to 102, 110, and 111 are identical to those in FIG. 2. In FIG. 10, an own vehicle information extraction section 400 is provided in the in-vehicle communication device 100. The own vehicle information extraction section 400 extracts the information on the own vehicle from among the items of information of the detection results of the in-vehicle sensor which have been transmitted from the other vehicle 40 and received by the wireless reception section 111.

Next, a description will be given of the operation.

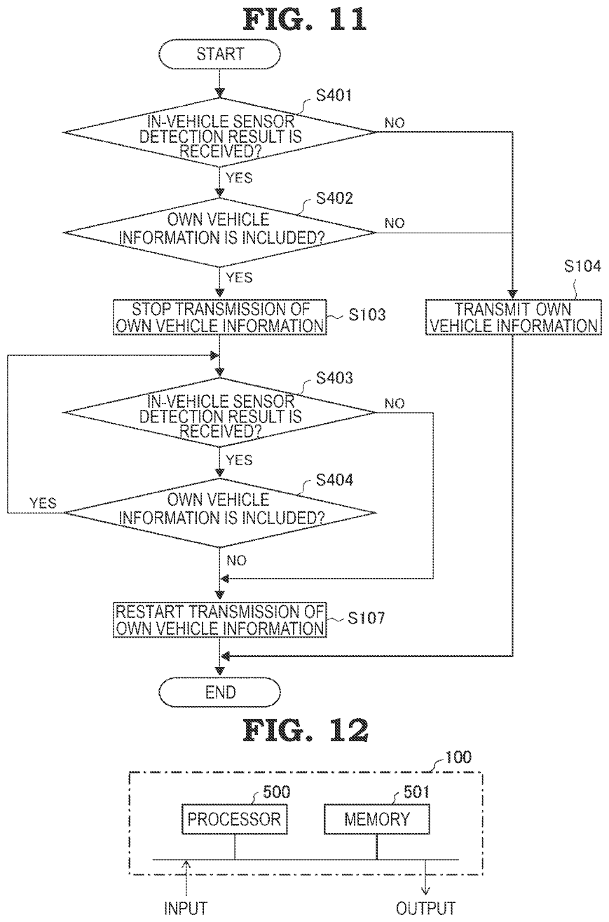

A description will be given, using FIG. 11, of the processing of the in-vehicle communication device 100 according to the fourth embodiment.

In FIG. 11, Steps S401 and S402 are added in place of Steps S101 and S102 of FIG. 3, and furthermore, Steps S403 and S404 are added in place of Steps S105 and S106.

Hereinafter, a description be given of the processing details of Steps S401 to S404.

In Step S401, the in-vehicle communication device 100 confirms whether or riot the wireless reception section 111 has received from the other vehicle 40 the detection result of the in vehicle sensor mounted on the other vehicle 40.

When the detection result is not received, the operation proceeds to Step S104. When the detection result is received, the operation proceeds to Step S402.

In Step S402, the in-vehicle communication device 100 is such that the own vehicle information extraction section 400 compares detected information of a vehicle (such as its position, speed, and orientation) with the information of the own vehicle (such as its position, speed, and orientation) acquired from the in-vehicle network 102 and, when there is a detection result, in which a difference therebetween falls within a predetermined range, among the detection results of the in-vehicle sensor of the other vehicle 40 received by the wireless reception section 111, extracts it as a detection result corresponding to that of the own vehicle.

When the detection result can be extracted, the operation proceeds to Step S103. When the detection result cannot be extracted, the operation proceeds to Step S104.

In Step S403, the in-vehicle communication device 100 confirms whether or not the wireless reception. section 111 has newly received from the other vehicle 40 a detection result of the in-vehicle sensor mounted on the other vehicle 40.

When the detection result cannot be received, the operation proceeds to Step S107. When the detection result is received, the operation proceeds to Step S404.

In Step S404, the in-vehicle communication device 100 carries out the same processing as in Step S402.

When a detection result corresponding to that of the own vehicle can be extracted, the operation returns to Step S403. When the detection result cannot be extracted, the operation. proceeds to Step S107.

According to the fourth embodiment, when it is determined that the other vehicle 40 has detected the own vehicle, the in-vehicle communication device 100 stops the processing of periodically wirelessly transmitting the information of the own vehicle.

It is thereby possible, even on a road on which the roadside device 2 is not installed, to avoid tightness or congestion of wireless communication when a large number of vehicles exist in the surroundings.

As one example of hardware is shown in FIG. 12, the in-vehicle communication device 100 is configured of a processor 500 and a memory 501. Although not shown, the memory includes a volatile memory, such as a random access memory, and a non-volatile auxiliary memory, such as a flash memory. Also, the memory may include a hard disk auxiliary memory in place of the flash memory. The processor 500 executes a program inputted from the memory 501. In this case, the program is inputted into the processor 500 from the auxiliary memory via the volatile memory. Also, the processor 500 may output data, such as a calculation result, to the volatile memory of the memory 501, and may also store the data into the auxiliary memory via the volatile memory.

Although the present application is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments.

It is therefore understood that numerous modifications which have not. been exemplified can be devised without departing from the scope of the present application. For example, at least one of the constituent components may be modified, added, or eliminated. At least one of the constituent components mentioned in at least one of the preferred embodiments may be selected and combined with the constituent components mentioned in another preferred embodiment.

What as claimed is:

1. An in-vehicle communication device which carries out road-to-vehicle and vehicle-to-vehicle communication, the device comprising:
a transmission circuitry which transmits information of an own vehicle;
a reception circuitry which receives the transmitted information; and
an own vehicle information extraction circuitry which, when the information is received by the reception circuitry, extracts information on the own vehicle from the information, wherein
the transmission circuitry stops the information transmission when the information on the own vehicle is extracted by the own vehicle information extraction circuitry.

2. The in-vehicle communication device according to claim 1, wherein
the information received by the reception circuitry is information transmitted by a roadside device.

3. The in-vehicle communication device according to claim 2, further comprising:
a roadside sensor accuracy extraction circuitry which, based on information on the distribution of detection accuracy of a roadside sensor in the roadside device, which is included in the information transmitted by the roadside device, extracts the detection accuracy of the roadside sensor corresponding to the position of the own vehicle, wherein
when the detection accuracy of the roadside sensor extracted by the roadside sensor accuracy extraction circuitry is equal to or higher than a first threshold, the transmission circuitry stops the transmission.

4. The in-vehicle communication device according to claim 2, still further comprising:
a surrounding congestion level calculation circuitry which, when information transmitted from another vehicle is received by the reception circuitry, calculates the level of congestion around the own vehicle from the information, wherein
when the level of congestion calculated by the surrounding congestion level calculation circuitry is equal co or higher than a second threshold, the transmission circuitry stops the transmission.

5. The in-vehicle communication device according to claim 1, wherein
the information received by the reception circuitry is information transmitted from another vehicle.

6. The in-vehicle communication device according to claim 3, wherein
when the detection accuracy of the roadside sensor extracted by the roadside sensor accuracy extraction circuitry is lower than the first threshold, the transmission circuitry restarts the stopped transmission.

7. The in-vehicle communication device according to claim 4, wherein
when the level of congestion calculated by the surrounding congestion level calculation circuitry is lower than the second threshold, the transmission circuitry restarts the stopped transmission.

8. The in-vehicle communication device according to claim 1, wherein
when the information on the own vehicle is not extracted by the own vehicle information extraction circuitry, the transmission circuitry restarts the stopped transmission.

9. The in-vehicle communication device according to claim 2, wherein
when the information on the own vehicle is not extracted by the own vehicle information extraction circuitry, the transmission circuitry restarts the stopped transmission.

10. The in-vehicle communication device according to claim 3, wherein
when the information on the own vehicle is not extracted by the own vehicle information extraction circuitry, the transmission circuitry restarts the stopped transmission.

11. The in-vehicle communication device according to claim 4, wherein
when the information on the own vehicle is not extracted by the own vehicle information extraction circuitry, the transmission circuitry restarts the stopped transmission.

12. The in-vehicle communication device according to claim 5, wherein
when the information on the own vehicle is not extracted by the own vehicle information extraction circuitry, the transmission circuitry restarts the stopped transmission.

13. The in-vehicle communication device according to claim 2, wherein
when the information transmitted by the roadside device is not received, the reception circuitry restarts the stopped transmission.

14. The in-vehicle communication device according to claim 3, wherein
when the information transmitted by the roadside device is not received, the reception circuitry restarts the stopped transmission.

15. The in-vehicle communication device according to claim 4, wherein
when the information transmitted by the roadside device is not received, the reception circuitry restarts the stopped transmission.

16. The in-vehicle communication device according to claim 5, wherein
when the information transmitted from another vehicle is not received, the reception circuitry restarts the stopped transmission.
